(19) United States
(12) Patent Application Publication
(10) Pub. No.: US 2005/0111774 A1
(43) Pub. Date: May 26, 2005

(54) Opto-Electronic Arrangement and Method

(75) Inventors: Markus Riester, Wiesbaden, Hessen (DE); Andreas Schaller, Wiesbaden, Hessen (DE)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 10/904,232

(22) Filed: Oct. 29, 2004

Related U.S. Application Data
(60) Provisional application No. 60/517,279, filed on Nov. 4, 2003.

(51) Int. Cl. G02B 6/12

(52) U.S. Cl. 385/14

(57) ABSTRACT

An opto-electronic arrangement (10) having integration of optical and electrical functions in a package on a PWB (20) with active temperature control. This provides the following advantage(s): Separation of highest cost optical function from main PWB; Active temperature control of optical function; Interconnect precision requirements are incorporated in the package assembly; Easy repair.

### DESCRIPTION

1. Field of the Invention

This invention relates to packaging of optical and electrical functions in opto-electronic systems.

2. Background of the Invention

In the field of this invention there is known, for example from U.S. Pat. No. 6,324,328, the incorporation of waveguides onto or into printed wiring boards (PWB), and the coupling of these waveguides with active and passive optical devices on or in the PWB. The incorporated waveguides can be manufactured using different technologies, all with the aim to establish a point-to-point connection that will guide light from one optical device on the PWB (e.g., a laser diode) to another optical device on the same PWB (e.g., an optical receiver). It is alternatively known to use prefabricated optical waveguide assemblies that are applied to the PWB by bonding on the surface.

From patent publication WO 01/75495 there is known the incorporation of optical devices for manipulating the light in the optical system, by, e.g., interferometric functions, or switch arrangements.

However, the known approaches have the disadvantage of lacking a cost effective and simple means of connecting advanced optical functions to an electrical PWB (Printed Wiring Board) with a standard interface, with or without waveguide technologies, and providing optical functionality in environments challenging for opto-electrical applications.

A solution is therefore needed for combining optics and electronics in a modular system on a PWB that alleviates the disadvantages of the existing solutions and provides an easy, cost-effective standard solution for integrating optical functions in printed wiring boards.

### STATEMENT OF INVENTION

The present invention allows active temperature control of critical locations on optical modules for optimized performance of the optical functions under environmental conditions that are found, but not limited to, telecommunication infrastructure network applications, and other similar environments.

As a result of the invention the operating temperature can be selected and maintained independent of the surrounding temperature, given that the operating temperature is higher than the surrounding temperature.

In accordance with the invention the temperature stability of the optical arrangement in the critical geometries can be precisely controlled by appropriate logic and sensors that are a part of the package or the main PWB.

In accordance with another feature of the invention, the time required for starting operation of the system can be minimized by using the embedded resistor heating structures to heat the optical devices to their operating temperatures, thus allowing a temperature equilibrium to be reached faster after switching on the equipment.

In accordance with yet another feature of the invention the arrangement allows the use of the excess heat developed by the system to be used as a heat source, thus minimizing the use of energy for heating the optical structures underneath the heat sink.

In accordance with yet another feature of the invention the described arrangement allows the high cost optical function to be manufactured and tested separately from the main PWB, similar to KGD (Known Good Die), and then placed on the main PWB with existing methods, e.g. Surface Mount Technology. This allows the use of existing tooling alleviating the need for high-precision placement tools in the assembly line.

In accordance with yet another feature of the invention the modularity of the arrangement allows the postponement of integration of the optical function, which can account for different requirements of different customers.

In accordance with yet another feature of the invention taking the modular approach allows the high-cost parts to be exchanged for repair. In case of failure of a component of the system this allows the fast and cost-effective repair of the system.

### BRIEF DESCRIPTION OF THE DRAWINGS(S)

One opto-electronic arrangement and method incorporating the present invention will now be described, by way of example only, with reference to the accompanying drawings, in which:

FIG. 1 shows a partly cross-sectional illustration of an opto-electronic arrangement attached to a backplane via a socket;

FIG. 2 shows an exploded partly cross-sectional illustration of an opto-electronic arrangement similar to that of FIG. 1, package and socket being shown separated;

FIG. 3 shows a partly cross-sectional illustration of the socket of FIG. 1 inserted in a backplane or main PWB; and

FIG. 4 shows a partly cross-sectional illustration of the socket of FIG. 1 inserted into an alternative backplane or main PWB.

### DESCRIPTION OF PREFERRED EMBODIMENT(S)

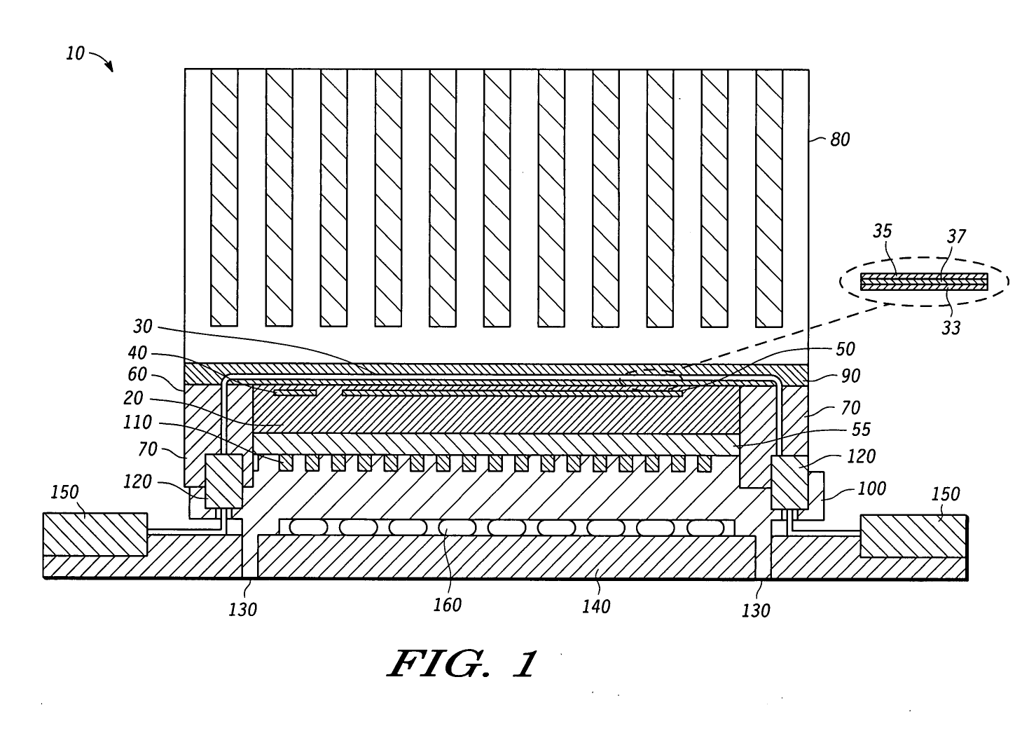

Referring firstly to FIG. 1, an opto-electronic arrangement 10 includes a PWB or circuit carrier 20 carrying an optical system layer 30. The PWB 20 also incorporates a thermal sensor 40 and an embedded resistive heater 50 electrically isolated from the optical layer 30. An electrical connection layer 55 is provided below the PWB 20. One or more further layers (not shown) may be provided for enhanced adhesion and/or additional electrical or thermal insulation. The PWB 20 is housed in a housing 60, which incorporates optical connectors 70. The PWB 20 may be attached to the housing 60 by bonding or other suitable attachment mechanisms. A heat sink 80 is coupled (by bonding or other appropriate methods) to the PWB 20 and optical system layer 30, and is separated therefrom (but thermally connected thereto) by a thermally conductive protection layer 90 which may cover the entire area of the PWB 20 or may be shaped according to the temperature field requirements of the optical devices in the optical layer 30. As shown in exploded dashed-line-bordered portion of FIG. 1, the optical layer 30 consists of three distinct regions: the bottom cladding 33, the top cladding 35 and the optical core layer 37 (having a refractive index higher than the surrounding cladding layers 33 and 35).

It will be understood that the housing 60 constitutes a mounting frame for the opto-electronic arrangement 20-40, improving the mechanical stiffness of the arrangement and providing a mounting for the circuit carrier and its optical and electrical connectors. The housing 60 mates with a socket 100 which provides electrical contacts 110 to the PWB 20 and provides optical couplings 120 to the optical system layer 30 (allowing the housing 60 to be placed on the socket 100 in satisfactory optical and electrical alignment without high-precision tools). The socket 100 has pins 130 which locate in a backplane 140. The backplane 140 has optical components 150 which are optically coupled to the optical couplings 120 in the socket 100. The backplane also provides soldered electrical connections 160 to the electrical contacts 110 in the socket 100.

The arrangement 10 allows the addition of complex optical functions to opto-electronic PWB 20 with optical system layer 30 without the need to incorporate complex optical functionality into the main PWB. Rather, the optical function is created on the PWB substrate by arbitrary means for creating optical waveguides, for example by technology such as compression molding, positive or negative photoimaging, etching, or others. The optical layer 30 on the PWB resides on the embedded resistive heating device 50. The power of the heater is actively controlled by control circuitry (not shown) and the integrated thermocouple 40. The heat sink 80, residing on top of the optical layer 30, has several functions:
dissipates energy from the opto-electronic device
controls heat flow to the device, thus allowing the passive use of heat energy supplied by the environment during operation and/or surrounding devices (not shown).

The opto-electronic PWB arrangement is connected to the backplane 140 (or main PWB) via the electrical and optical connectors 160 and 120. The electrical connections 160 supply power and data. The optical connections provide data exclusively.

The arrangement 10 allows the use of temperature sensitive planar optical devices on PWBs without the need of incorporating them into the main PWB. The connections to the optical module can either be electrical or optical, or both, depending upon requirements. The module can be placed by SMT compatible processes, leveraging the assembly technology existing for semiconductor devices on PWBs.

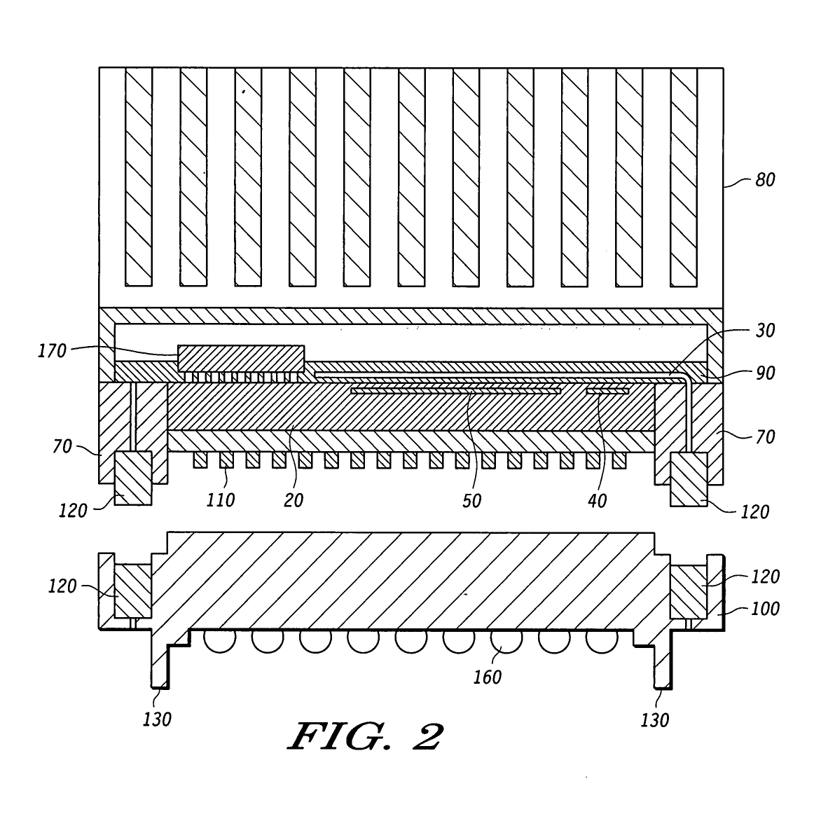

FIG. 2 shows an exploded view of an opto-electronic PWB, housing and socket arrangement, similar to that of FIG. 1, in which the housing and socket portions are separated. In FIG. 2, like components to those of FIG. 1 are given the same reference numerals. In the PWB 20 shown in FIG. 2 an integrated circuit 170 is provided, soldered to the PWB.

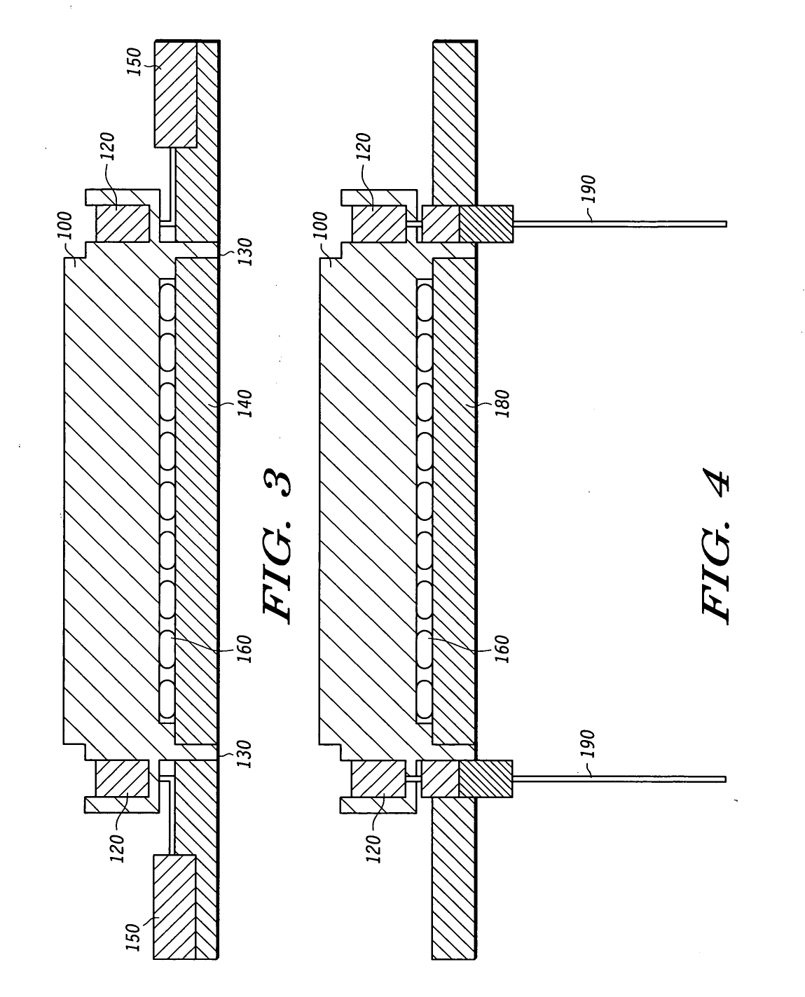

FIG. 3 shows a partial view of the arrangement of FIG. 1, in which like components to those of FIG. 1 are given the same reference numerals. As illustrated in FIG. 3, the pins 130 of the socket 100 provide mechanical stability and locate in cooperating holes in the backplane or main PWB 140.

FIG. 4 shows a partial view, similar to that of FIG. 3, in which like components are given the same reference numerals. As illustrated in FIG. 4, the pins 130 of the socket 100 provide mechanical stability and locate in cooperating holes in an alternative backplane or main PWB 180. In the backplane 180 optical couplers 190 extend through the backplane or PWB and waveguides extend therefrom perpendicularly to the backplane 180.

It will be understood that the optical layer 30 may be a single-mode or multi-mode optical transport layer, and may be fabricated by sol-gel processing, UV optical lithography, known imprinting techniques or a combination of these fabrication techniques. It will also be understood that the optical layer may be a pre-fabricated component that is bonded on the circuit carrier or PWB 20, and that the optical layer may or may not be connectorized at the point of assembly as desired. It will also be understood that the thermal sensor 40 may provide digital or analog information on the thermal conditions at its location to control circuitry for feedback control, and may be a separate device or integrated with other electrical components. It will also be understood that the electrical connectors 160 may be ball-grid array (BGA) or other standard type connections.

It will be appreciated that key features of the opto-electronic module in the arrangement 10 are that:
the module is SMT-compatible, with each of its components (plug, adapter, heat sink and module PWB) being SMT-compatible
the adapter may function as an integrated connector (for mechanical, optical and/or electrical connection) and/or may provide a heat sink fastening mechanism
the plug comprises an integrated connector (for mechanical, optical and/or electrical connection)
the heat sink may perform energy harvesting from the system during operation at equilibrium temperature for conserving electrical energy and/or may be connected to the adapter
the module PWB
   (1)has a layer structure which may contain an embedded resistive heater and/or an electrical layer
   (2)form a connection (mechanical, optical and/or electrical) to the frame
   (3)may include discrete devices and/or embedded devices
   (4)has an outside optical layer which may be an additional layer structured on the PWB and/or may be one or more multiple layers and/or may be formed by bonding an optical layer sheet (with or without connectors)
has electrical functions which may include a heater (an embedded heater and/or a heat spreader passive heater) and/or logic circuitry (logic-on-module and/or logic-on-board) for heater control)
has optical functions which:
may be single mode or multi mode
may comprise waveguides
may comprise devices with complex functionality, such as active (e.g., VOA —Variable Optical Attenuator—or optical switch) and/or passive devices (e.g., CWDM—Coarse Wavelength Division Multiplexing, OADM—Optical Add/Drop Multiplexer or thermo-optical switch).

It will thus be understood that the arrangements described above provide a solution to interconnect and temperature control issues with planar optical waveguide structures or optical devices integrated into or onto printed wiring boards. Notable features of the arrangements are:
reduced temperature sensitivity
achieving optical functionality in planar devices on printed wiring boards
connection of optical or electro-optical circuits to electrical PWBs by using standardized optical/electrical sockets for every opto-electrical module placed on a PWB.

Additionally, the arrangements add to Surface Mount technology the possibility of incorporating optical functions like optical switching, wavelength division multiplexing, and add/drop multiplexing.

It will be appreciated that the opto-electronic arrangement and method described above provides the following advantages:
Separation of high cost optical function from main PWB
Active temperature control of optical function
Interconnect precision requirements are incorporated in the package assembly
Easy repair.

1. An opto-electronic arrangement, comprising:
a circuit carrier with an optical layer;
at least one other layer providing electrical connections and a thermal sensing function;
a mounting frame on which the circuit carrier and the at least one further layer are mounted and which provides mechanical stiffness to the arrangement.

2. The opto-electronic arrangement according to claim 1 wherein the optical layer comprises first and second cladding layers and therebetween a third optical core layer having an index of refraction higher than the that of the first and second cladding layers.

3. The opto-electronic arrangement according to claim 1 wherein the at least one other layer provides at least one of A-D:
A thermal connection,
B enhanced adhesion,
C electrical insulation,
D thermal insulation.

4. The opto-electronic arrangement according to claim 2, wherein said circuit carrier contains at least one electrically conducting layer separated from the optical core layer by at least one non-conductive layer.

5. The opto-electronic arrangement according to claim 4, wherein the non-conductive layer comprises a cladding layer.

6. The opto-electronic arrangement according to claim 1, where the optical layer is suitable for single-mode optical transport.

7. The opto-electronic arrangement according to claim 1, where the optical layer is suitable for multi-mode optical transport.

8. The opto-electronic arrangement according to claim 1, where the optical layer is structured by at least one of E-G:
E sol-gel processing,
F UV optical lithography,
G imprinting techniques.

9. The opto-electronic arrangement according to claim 1, wherein the optical layer is a prefabricated component that is bonded on the circuit carrier.

10. The opto-electronic arrangement according to claim 1, having a planar resistive heater embedded in the circuit carrier for providing thermal energy to the arrangement, said resistive heater being electrically isolated from the optical layer.

11. The opto-electronic arrangement according to claim 10, having a heat distribution layer for distributing thermal energy generated by said resistive heater.

12. The opto-electronic arrangement according to claim 1, having a heat sink mounted on the circuit carrier.

13. The opto-electronic arrangement according to claim 12, the heat sink being arranged for harvesting thermal energy from the system during operation at equilibrium temperature for conserving electrical energy.

14. The opto-electronic arrangement according to claim 12, having a thermally conductive layer between the optical layer and the heat sink.

15. The opto-electronic arrangement according to claim 1, having an integrated control loop with feedback for determining and controlling thermal conditions in the arrangement.

16. The opto-electronic arrangement according to claim 1, arranged for using control logic external to the arrangement with feedback for determining and controlling thermal conditions in the arrangement.

17. The opto-electronic arrangement according to claim 1, wherein the circuit carrier comprises a thermal sensor, said thermal sensor providing information on thermal conditions at its location.

18. The opto-electronic arrangement according to claim 1, having electrical connections for providing power to the arrangement.

19. The opto-electronic arrangement according to claim 1, having electrical connections for providing data exchange.

20. The opto-electronic arrangement according to claim 19, wherein said electrical connections for providing data exchange are of ball-grid array (BGA) type.

21. The opto-electronic arrangement according to claim 1, having optical connectors for providing light transmission from the arrangement.

22. The opto-electronic arrangement according to claim 1, having a socket that holds the circuit carrier, the at least one other layer and the mounting frame.

23. The opto-electronic arrangement according to claim 22, the socket and the mounting frame having cooperating mechanical alignment structures allowing an optical connection to be established between the optical layer and the socket.

24. A method for producing an opto-electronic arrangement, comprising:
providing a circuit carrier with an optical layer;
providing at least one other layer providing electrical connections and a thermal sensing function;
providing a mounting frame on which the circuit carrier and the at least one further layer are mounted and which provides mechanical stiffness to the arrangement.

25. The method according to claim 24 wherein the optical layer comprises first and second cladding layers and therebetween a third optical core layer having an index of refraction higher than the that of the first and second cladding layers.

26. The method according to claim 24 wherein the at least one other layer provides at least one of A-D:
A thermal connection,
B enhanced adhesion,
C electrical insulation,
D thermal insulation.

27. The method according to claim 25, wherein said circuit carrier contains at least one electrically conducting layer separated from the optical core layer by at least one non-conductive layer.

28. The method according to claim 27, wherein the non-conductive layer comprises a cladding layer.

29. The method according to claim 24, where the optical layer is a single-mode optical layer.

30. The method according to claim 24, where the optical layer is a multi-mode optical layer.

31. The method according to claim 24, where the optical layer is structured by at least one of E-G:
E sol-gel processing,
F UV optical lithography,
G imprinting techniques.

32. The method according to claim 24, wherein the optical layer is a prefabricated component that is bonded on the circuit carrier.

33. The method according to claim 24, wherein said optical layer is connectorized at point of assembly.

34. The method according to claim 24, including providing a planar resistive heater embedded in the circuit carrier for providing thermal energy to the arrangement, said resistive heater being electrically isolated from the optical layer.

35. The method according to claim 34, including providing a heat distribution layer for distributing thermal energy generated by said resistive heater.

36. The method according to claim 24, including providing a heat sink mounted on the circuit carrier.

37. The method according to claim 36, the heat sink being arranged for harvesting thermal energy from the system during operation at equilibrium temperature for conserving electrical energy.

38. The method according to claim 36, including providing a thermally conductive layer between the optical layer and the heat sink.

39. The method according to claim 24, including providing an integrated control loop with feedback for determining and controlling thermal conditions in the arrangement.

40. The method according to claim 24, including providing external control logic with feedback for determining and controlling thermal conditions in the arrangement.

41. The method according to claim 24, wherein the circuit carrier comprises a thermal sensor, said thermal sensor providing information on thermal conditions at its location in the arrangement.

42. The method according to claim 24, including providing electrical connections for providing power to the arrangement.

43. The method according to claim 24, including providing electrical connections for providing data exchange.

44. The method according to claim 43, wherein said electrical connections for providing data exchange are of ball-grid array (BGA) type.

45. The method according to claim 43, including providing optical connectors for providing light transmission from the arrangement.

46. The method according to claim 24, including providing a socket that holds the circuit carrier, the at least one other layer and the mounting frame.

47. The method according to claim 23, the socket and the mounting frame having cooperating mechanical alignment structures allowing an optical connection to be established between the optical layer and the socket.
